(19) United States
(12) Patent Application Publication
(10) Pub. No.: US 2025/0023335 A1
(43) Pub. Date: Jan. 16, 2025

(54) WIRE HARNESS

(71) Applicant: Proterial, Ltd., Tokyo (JP)

(72) Inventors: Hirotaka ESHIMA, Tokyo (JP); Yoshikazu HAYAKAWA, Tokyo (JP); Takahiro FUTATSUMORI, Tokyo (JP)

(21) Appl. No.: 18/756,483

(22) Filed: Jun. 27, 2024

(30) Foreign Application Priority Data
Jul. 14, 2023 (JP) 2023-115885

(51) Int. Cl. H02G 3/04; B60R 16/02

(52) U.S. Cl. CPC H02G 3/0462; B60R 16/0215

(57) ABSTRACT

A wire harness is provided with a first cable and a second cable, each having a plurality of wires, a connector at one end of the first cable, and a protective member covering at least a portion of the plurality of wires of the second cable.

### CROSS-REFERENCE TO RELATED APPLICATIONS

The present patent application claims the priority of Japanese patent application No. 2023-115885 filed on Jul. 14, 2023, and the entire contents thereof are hereby incorporated by reference.

### TECHNICAL FIELD

This disclosure relates to a wire harness.

### BACKGROUND OF THE INVENTION

Conventionally, a wire harness having multiple connectors and cables is used, for example, to electrically connect multiple connection objects in a vehicle. The wire harness described in Patent Literature 1 describes a wire harness equipped with a first wire group, one end of which is connected to a first connector and the other end to a second connector, and a second wire group, one end of which is connected to the first connector and the other end is connected to a third connector while diverging from the first wire group at the position of the second connector or a connection object to the second connector. In the portion between the second and third connectors, an exterior material such as corrugated tubing or adhesive tape wound in a spiral shape is provided to cover the second wire group.

### Citation List

Patent Literature 1: Japanese Patent No. 6761398

### SUMMARY OF THE INVENTION

When a wire harness configured as described above is placed between a body-side and a wheel-side in a vehicle, for example, it is prone to chipping caused by stepping stones and other objects bounced up by the tires. In the one described in Patent Literature 1, the second wire group is protected by an exterior material. However, when a corrugated tube is used as the exterior material, if the position of the corrugated tube in the longitudinal direction of the second wire group is not fixed, the area prone to chipping may not be properly protected. In addition, when adhesive tape is used as an exterior material, an additional operation is required to wind the adhesive tape in a spiral shape and there is a risk of peeling due to a decrease in adhesiveness over time.

Therefore, it is an object of the present invention to provide a wire harness comprising a first cable and a second cable, each having a plurality of wires, a connector arranged at one end of the first cable, and a protective member covering at least a portion of the plurality of wires of the second cable, that can properly protect the plurality of wires of the second cable.

To solve the above problem, one aspect of the present invention provides a wire harness comprising:
a first cable and a second cable, each having a plurality of wires;
a one-side connector at one end of the first cable; and
a protective member covering at least a portion of the plurality of wires of the second cable,
wherein one end of the protective member is covered by a molded body together with the one-side connector.

### Effects of the Invention

Accordingly, it is possible to provide a wire harness that can properly protect the plurality of wires of the second cable.

### BRIEF DESCRIPTION OF DRAWINGS

FIG. 1 is a schematic diagram showing a configuration example of a vehicle equipped with a wire harness according to the first embodiment.

FIG. 2A is an enlarged partial view of FIG. 1.

FIG. 2B is an explanatory diagram showing a resin tube in FIG. 2A in two dotted lines virtually and the interior of the resin tube in solid lines.

FIG. 3 is a configuration diagram of a wire harness.

FIG. 4A is a sectional view taken along the line A-A of FIG. 3.

FIG. 4B is a sectional view taken along the line B-B of FIG. 3.

FIG. 4C is a sectional view taken along the line C-C of FIG. 3.

FIG. 5 is an explanatory diagram illustrating the first connector and its surrounding wiring configuration.

FIG. 6 is a configuration diagram showing a modified example of the wiring structure for trunk and branch cables.

FIG. 7 is a configuration diagram showing a modified example in which a heat-shrinkable tube is placed between the tip of the resin tube at the third connector side and the third connector.

FIG. 8A is a configuration diagram of a wire harness according to the second embodiment.

FIG. 8B is a sectional view taken along the line D-D of FIG. 8A.

FIG. 9A is a configuration diagram of a wire harness according to the third embodiment.

FIG. 9B is a sectional view of a branch cable and a sensor section of the wire harness according to the third embodiment.

### DETAILED DESCRIPTION OF THE INVENTION

### First Embodiment

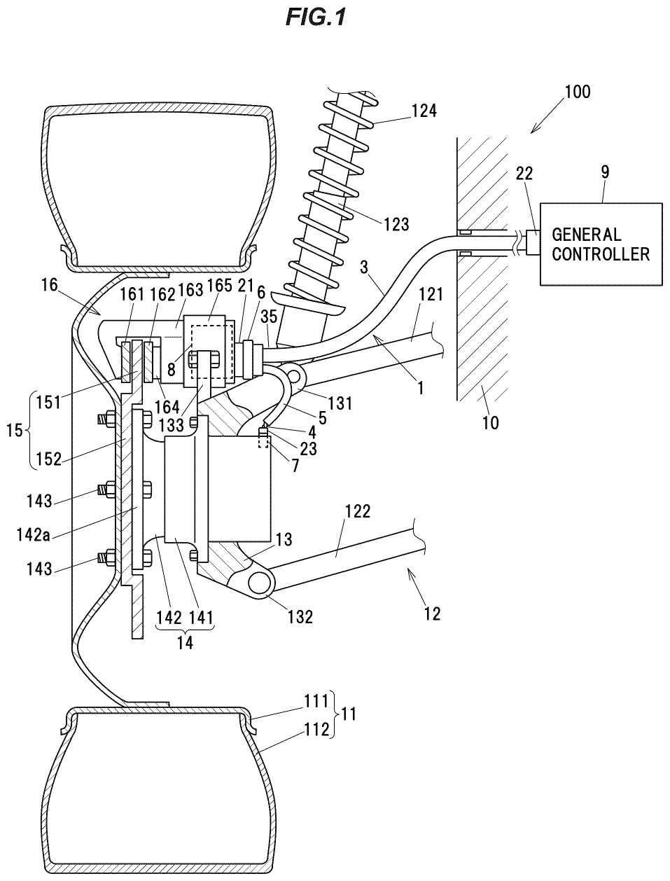

FIG. 1 is a schematic diagram showing a configuration example of a vehicle 100 equipped with a wire harness 1 according to the first embodiment. In the vehicle 100, a vehicle wheel 11 having a wheel 111 and a tire 112 is supported against a vehicle body 10 by a suspension system 12. The suspension system 12 comprises an upper arm 121, a lower arm 122, a damper 123, and a suspension spring 124. The upper arm 121 and the lower arm 122 are respectively connected at one end to a knuckle 13 and at the other end to the vehicle body 10.

The knuckle 13 has a first connecting section 131 to which the upper arm 121 and the damper 123 are connected, a second connecting section 132 to which the lower arm 122 is connected, and a mounting section 133 to which an electric brake unit 16 is attached. An outer wheel 141 of a hub unit 14, which rotatably supports the vehicle wheel 11, is fixed to the knuckle 13.

The hub unit 14 has the outer wheel 141 and a hub wheel 142 that is rotatably supported with respect to the outer wheel 141. A plurality of rolling elements that are not shown in the drawings are arranged between the inner surface of the outer wheel 141 and the outer surface of the hub wheel 142, held by a retainer. The hub wheel 142 has a wheel mounting flange 142a, to which the wheel 111 is attached together with a brake rotor 15 by a plurality of hub bolts 143. The brake rotor 15 integrally has a friction portion 151 that frictionally slides with the brake pads 161, 162 of the electric brake unit 16 and a fixing portion 152 that is fixed to the wheel mounting flange 142a of the hub wheel 142.

A wheel speed sensor 7 is mounted on the outer wheel 141 of the hub unit 14. The wheel speed sensor 7 detects the rotation speed of the hub wheel 142 relative to the outer wheel 141 as the rotation speed of the vehicle wheel 11. Specifically, it detects changes in the magnetic field of a magnetic encoder attached to the hub wheel 142 using a Hall IC or other magnetic field detection element, and outputs a pulse signal with a pulse interval corresponding to the rotation speed of the hub wheel 142 relative to the outer wheel 141 as a detection signal.

The electric brake unit 16 has an outer brake pad 161 and an inner brake pad 162, a caliper 163 with the outer brake pad 161 attached, a piston 164 with the inner brake pads 162 attached, and a caliper bracket 165 fixed to the mounting section 133 of the knuckle 13. The caliper 163 is supported by the caliper bracket 165 and can move parallel to the axis of rotation of the vehicle wheel 11.

The vehicle 100 has a brake controller 8 that controls the electric brake unit 16 and a general controller 9 that integrally controls the vehicle 100. The brake controller 8 and wheel speed sensor 7 are located on the vehicle wheel side and move vertically with the vehicle wheels 11 relative to the vehicle body 10 as a suspension spring 124 extends and retracts. The general controller 9 is located on the vehicle body side. The brake controller 8 is an aspect of “wheel-side control device” of this disclosure and the general controller 9 is an aspect of “body-side control device” of this disclosure.

The wire harness 1 connects the brake controller 8, the wheel speed sensor 7, and the general controller 9. Next, the configuration of the wire harness 1 will be explained in detail.

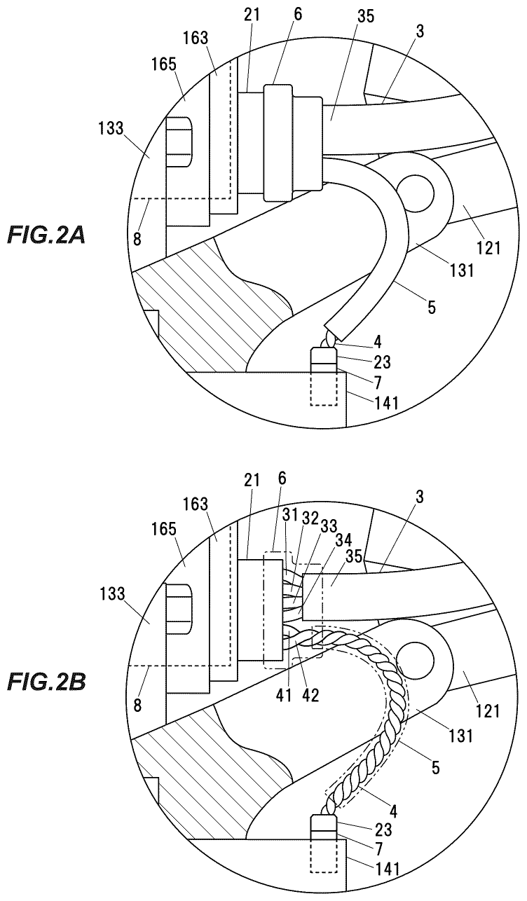

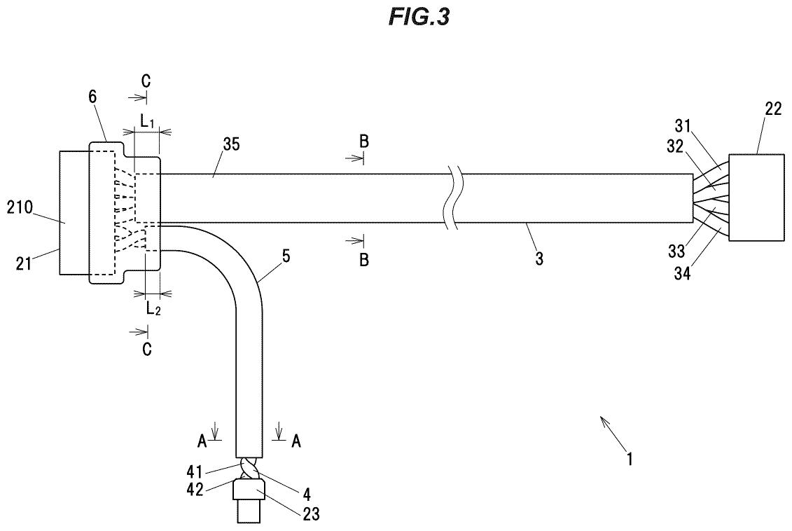

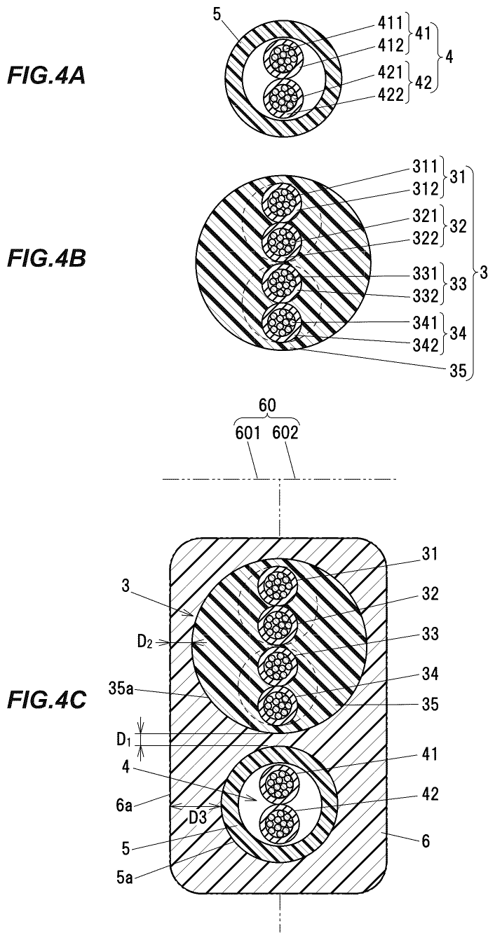

FIG. 2A is an enlarged partial view of FIG. 1. FIG. 2B is an explanatory diagram of the wire harness 1 in the portion shown in FIG. 2A, showing a resin tube 5 in two dotted lines virtually and the interior of the resin tube 5 in solid lines. FIG. 3 is a configuration diagram of the wire harness 1. FIG. 4A is a sectional view taken along the line A-A of FIG. 3. FIG. 4B is a sectional view taken along the line B-B of FIG. 3. FIG. 4C is a sectional view taken along the line C-C of FIG. 3.

The wire harness 1 has a first connector 21 that is detachably attached to the brake controller 8, a second connector 22 that is detachably attached to the general controller 9, a trunk cable 3 between the first connector 21 and the second connector 22, a branch cable 4 that extends from the first connector 21 side in the direction different from the trunk cable 3, a third connector 23 which is arranged at the end of the branch cable 4 and detachably attached to the wheel speed sensor 7, the resin tube 5 as a protective member covering at least a portion of the plurality of wires of the branch cable 4, and a molded body 6, which was made by molding. FIG. 4C shows a mold 60 for molding the molded body 6 in two dotted lines.

The trunk cable 3 and the branch cable 4 have a plurality of wires respectively. In the present embodiment, the trunk cable 3 and the branch cable 4 have a plurality of signal lines as a plurality of electric wires. However, some or all of the plurality of wires that the trunk cable 3 and the branch cable 4 have may be power lines or ground lines.

The first connector 21 is an aspect of the “one-side connector” of this disclosure, and the second connector 2 is an aspect of the “other-side connector” of this disclosure. The trunk cable 3 is an aspect of the “first cable” of this disclosure, and the branch cable 4 is an aspect of the “second cable” of this disclosure. The trunk cable 3 is longer than the branch cable 4, has more wires than the branch cable 4, and has a larger outer diameter than the branch cable 4.

The trunk cable 3 has first through fourth signal lines 31 to 34 and a sheath 35 covering the first through fourth signal lines 31 to 34. The first signal line 31 and the second signal line 32, and the third signal line 33 and the fourth signal line 34 are twisted together to form a twisted pair wire respectively. Additionally, the first signal line 31 and the second signal line 32 may be covered by an internal sheath. The third signal line 33 and the fourth signal line 34 may be also covered by an internal sheath.

The first through fourth signal lines 31 to 34 are insulated wires consisting of center conductors 311, 321, 331, 341 covered by insulators 312, 322, 332, 342. The center conductors 311, 321, 331, 341 are stranded wires consisting of a plurality of strands made of copper or copper alloys twisted together. The insulators 312, 322, 332, 342 are made of an insulating resin such as polyethylene or fluororesin. The sheath 35, the outermost layer of trunk cable 3, is made of urethane resin, for example. In the present embodiment, the sheath 35 is formed by full extrusion (solid extrusion). In the present embodiment, the trunk cable 3 is provided with the first through fourth signal lines 31 to 34 (signal lines only), but it may be provided with multiple power lines (to supply power to the electric brake unit 16) and multiple signal lines in combination.

The branch cable 4 consists of the fifth and sixth signal lines 41, 42. The fifth and sixth signal lines 41, 42 extend from the first connector 21 side of the two ends of the trunk cable 3 toward the wheel speed sensor 7. The fifth and sixth signal lines 41, 42 are insulated wires consisting of center conductors 411, 421 covered by insulators 412, 422, and twisted together to form a twisted pair cable. The center conductors 411, 421 are stranded wires consisting of a plurality of strands made of copper or copper alloys twisted together. The insulators 412, 422 are made of an insulating resin such as polyethylene or fluororesin. The fifth and sixth signal lines 41 and 42 may not be twisted together. The fifth and sixth signal lines 41, 42 transmit detection signals of the wheel speed sensor 7.

The resin tube 5 is a cylindrical body that accommodates the fifth and sixth signal lines 41, 42, and the fifth and sixth signal lines 41, 42 are inserted into the resin tube 5. The resin tube 5 is made of urethane resin, for example. In the present embodiment, the resin tube 5 covers the almost entirety of the fifth and sixth signal lines 41, 42 between the first connector 21 and the third connector 23, except in the vicinity of the third connector 23. However, the resin tube 5 may cover at least a portion of the fifth and sixth signal lines 41, 42 between the first connector 21 and the third connector 23 in the longitudinal direction, or may cover the whole of the fifth and sixth signal lines 41, 42. The resin tube 5 may be formed with a pre-bent portion along the wiring path of the branch cable 4. Also, the gap at the end of the third connector 23 side in the resin tube 5 may be sealed by an adhesive, silicone, or other filler.

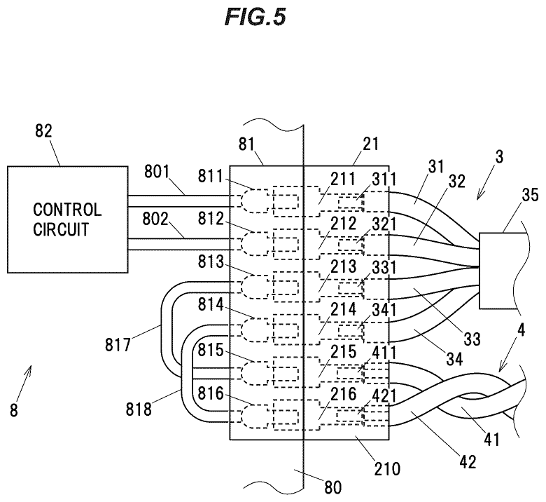

FIG. 5 is an explanatory diagram illustrating the first connector 21 and its surrounding wiring configuration. The first connector 21 has first through sixth terminals 211 to 216 and a resin connector housing 210 that holds the first through sixth terminals 211 to 216. The first through sixth terminals 211 to 216 are crimped to the respective center conductors 311, 321, 331, 341, 411, 421 of the first through sixth signal lines 31 to 34, 41, 42. The connector housing 210 accommodates a portion of each of the first through sixth signal lines 31 to 34, 41, 42 and a portion of each of the first through sixth terminals 211 to 216.

The first connector 21 is mated to a connection connector 81 mounted on a substrate 80 of the brake controller 8. The connection connector 81 has first to sixth connection terminals 811 to 816 to which the first to sixth terminals 211 to 216 of the first connector 21 are connected respectively. Of these, the first and second connection terminals 811, 812 are connected to a control circuit 82 of the brake controller 8 by wiring patterns 801, 802 formed on the substrate 80. The control circuit 82 controls the electric motor that is the driving source of the electric brake unit 16 based on the control signals sent from the general controller 9. The caliper 163 and piston 164 of the electric brake unit 16 are operated by the driving force of the electric motor.

The brake controller 8 and the general controller 9 communicate via the first and second signal lines 31, 32 of the trunk cable 3. The first and second signal lines 31, 32 transmit control signals between the brake controller 8 and the general controller 9. The control signals sent from the general controller 9 to the brake controller 8 include information on the braking force of the vehicle wheel 11 to be generated by the electric brake unit 16. The control signals sent from the brake controller 8 to the general controller 9 include information indicating the operating state of the electric brake unit 16, such as the rotation speed of the electric motor and the current supplied to the electric motor.

The third connection terminal 813 and the fifth connection terminal 815, and the fourth connection terminal 814 and the sixth connection terminal 816 of the connection connector 81 are electrically shorted respectively. As a result, the center conductor 411 of the fifth signal line 41 of the branch cable 4 is electrically connected to the center conductor 331 of the third signal line 33 of the trunk cable 3, and a center conductor 421 of the sixth signal line 42 of the branch cable 4 is electrically connected to a center conductor 341 of the fourth signal line 34 of the trunk cable 3.

In the example shown in FIG. 5, a shorting member 817 electrically connects the third connection terminal 813 to the fifth connection terminal 815, and a shorting member 818 electrically connects a fourth connection terminal 814 to the sixth connection terminal 816. The shorting members 817 and 818 are metal fittings made of conductive metal. Also, the third connection terminal 813 and the fifth connection terminal 815, and the fourth connection terminal 814 and the sixth connection terminal 816 may be electrically short-circuited by a wiring pattern formed on the substrate 80, for example.

The detection signals of the wheel speed sensor 7 transmitted by the fifth and sixth signal lines 41, 42 propagate to the third and fourth signal lines 33, 34 of the trunk cable 3 via the shorting members 817, 818, and are sent to the general controller 9 by the third and fourth signal lines 33, 34 of the trunk cable 3. The general controller 9 sends a control signal to the brake controller 8 based on the rotational speed of the vehicle wheel 11 obtained by the detection signal of the wheel speed sensor 7. The control of the braking force by the general controller 9 includes antilock control to suppress locking of the vehicle wheel 11. Alternatively, a part of the function of controlling the braking force may be provided to the brake controller 8. In this case, the detection signal of the wheel speed sensor 7 is also input to the control circuit 82 of the brake controller 8.

One end at the first connector 21 side in the resin tube 5 is covered by the molded body 6 together with a part of the first connector 21. The molded body 6 also covers a part at the first connector 21 side in the sheath 35 of the trunk cable 3. In FIG. 3, the first through fourth signal lines 31 to 34 and the sheath 35 of the trunk cable 3, the fifth and sixth signal lines 41, 42 of the branch cable 4, and the resin tube 5 inside the molded body 6 are shown as dotted lines.

In manufacturing the wire harness 1, the first connector 21, the trunk cable 3, the branch cable 4, and the resin tube 5 are placed in a mold for forming the molded body 6, and molten resin is injected into the cavity of the mold. When the molten resin cools and solidifies, it becomes the molded body 6. Additionally, connect the first through sixth signal lines 31 to 34, 41, 42 in advance to the first through sixth terminals 211 to 216 of the first connector 21, and retain the first through sixth terminals 211 to 216 in the connector housing 210, before molding the molded body 6. To prevent the molten resin from entering the resin tube 5, the end at the first connector 21 side in the resin tube 5 is closed by, for example, a cap-shaped closure member.

The mold 60 for forming the molded body 6 comprises a upper mold 601 and a lower mold 602 that are split in half. During molding of the molded body 6, the upper mold 601 and the lower mold 602 hold the sheath 35 and the resin tube 5 of the trunk cable 3 by sandwiching them from the upper and lower sides. Therefore, since the upper mold 601 and the lower mold 602 do not contact the first through sixth signal lines 31 to 34, 41, 42, it is possible to prevent the first through sixth signal lines 31 to 34, 41, 42 from contacting the mold 60 and being damaged. In the molded body 6, the trunk cable 3 and the branch cable 4 are arranged so that the straight line connecting the center of the sheath 35 and the center of the resin tube 5 is roughly parallel to the long side of the molded body 6 (the side in the vertical direction in FIG. 4C).

The molded body 6 is made of, for example, urethane resin. In the first connector 21, a portion of the connector housing 210 covered by the molded body 6 is welded to the molded body 6 by the heat of the molten resin when the molded body 6 is molded. When the molded body 6 is made of urethane resin, it is desirable to use urethane resin, which is the same type of resin as the molded body 6, or polyamide, which is a resin with high weldability with urethane resin, as the material of the connector housing 210 in order to improve the weldability with the connector housing 210. Furthermore, to prevent the molded body 6 from detaching from the connector housing 210, the connector housing 210 and the molded body 6 may be provided with an uneven shape that has an anchor effect.

The resin tube 5 is welded to the molded body 6 by the heat of the molten resin when the molded body 6 is formed. The sheath 35 of the trunk cable 3 is also welded to the molded body 6 in the same manner. To ensure that these welds are made securely, the molded body 6, the resin tube 5, and the sheath 35 of the trunk cable 3 should be made of the same type of resin. In the present embodiment, the molded body 6, the resin tube 5, and the sheath 35 of the trunk cable 3 are made of urethane resin.

As shown in FIG. 4C, the resin tube 5 and sheath 35 are separated from each other in the molded body 6. As a result, the resin constituting the molded body 6 is interposed between the resin tube 5 and the sheath 35 as well, and the fixation of the resin tube 5 and the sheath 35 to the molded body 6 is strengthened. Furthermore, the molten resin used to form the molded body 6 also enters between the resin tube 5 and the sheath 35, thereby enhancing the weldability of the molded body 6, the resin tube 5, and the sheath 35.

Inside the molded body 6, it is desirable that a distance D₁ between the resin tube 5 and the sheath 35 be 1.0 mm or more and 10.0 mm or less. Considering the strength of a part of the mold 60 that is interposed between the resin tube 5 and the sheath 35 when molding the molded body 6, and also considering the suppression of the enlargement of the molded body 6, it is more desirable that the distance D₁ between the resin tube 5 and the sheath 35 inside the molded body 6 be 2.0 mm or more and 8.0 mm or less.

As shown in FIG. 4C, the shortest distance D₂ from the outer circumferential surface 35a of the sheath 35 to the outer circumferential surface 6a of the molded body 6 is longer than the distance D₁ between the resin tube 5 and the sheath 35. Similarly, as shown in FIG. 4C, the shortest distance D₃ from the outer circumferential surface 5a of the resin tube 5 to the outer circumferential surface 6a of the molded body 6 is longer than the distance D₁ between the resin tube 5 and the sheath 35.

Here, the sheath 35 of the trunk cable 3 is thicker than the resin tube 5 and has a larger heat capacity, and thus, the surface of the sheath 35 is less likely to melt due to the heat of the molten resin than the resin tube 5, making it difficult to weld with the molded body 6. In the present embodiment, as shown in FIG. 3, a length L₁ of the sheath 35 in a part covered by the molded body 6, is longer than a length L₂ of the resin tube 5 in a part covered by the molded body 6, which makes it easier for the sheath 35 to weld with the molded body 6.

The connector housing 210, the resin tube 5, and the sheath 35 of the trunk cable 3 need not necessarily be welded to the molded body 6, but only need to be tightly adhered so that they cannot be easily pulled out of the molded body 6. However, if the connector housing 210, the resin tube 5, and the sheath 35 of the trunk cable 3 are welded to the molded body 6 to form a single unit, water penetration through a small gap between them is prevented and high waterproof property is achieved.

### Effect of the First Embodiment

According to the first embodiment described above, the end of the resin tube 5 on the side of the first connector 21 is covered by the molded body 6 together with a part of the first connector 21, so that the resin tube 5 is prevented from being misaligned with the first connector 21, and the branch cable 4 can be properly protected by the resin tube 5. This makes it possible to suppress damage due to chipping, or the like of the branch cable 4. In addition, since the connector housing 210, the resin tube 5, and the sheath 35 of the trunk cable 3 are welded to the molded body 6 in the present embodiment, water penetration into the interior of the molded body 6 can be suppressed and waterproofing in the molded body 6 can be improved.

### Modified Example of Wiring Structure for Trunk and Branch Cables

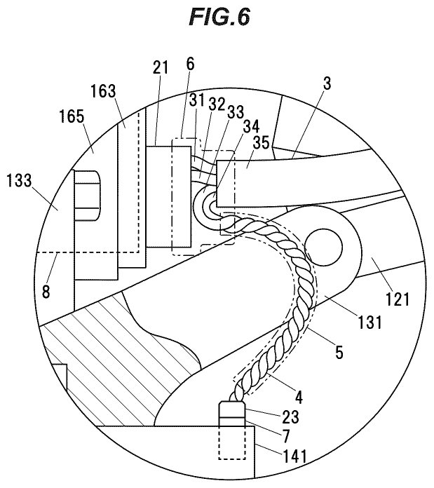

FIG. 6 is a configuration diagram showing a modified example of the wiring structure for the trunk cable 3 and the branch cable 4. In FIG. 6, as in FIG. 2, the resin tube 5 is shown virtually as two dotted lines, and the interior of the resin tube 5 is shown as solid lines. In the first embodiment described above, the fifth and sixth signal lines 41, 42 of the branch cable 4 are electrically connected to the third and fourth signal lines 33, 34 of the trunk cable 3. However, in the modified example shown in FIG. 6, the third and fourth signal lines 33 and 34 of the trunk cable 3 that are derived from the sheath 35 inside the molded body 6 are introduced into the resin tube 5 without passing through the first connector 21 or the brake controller 8 to form the branch cable 4. In other words, in the first embodiment described above, the branch cable 4 is separate from the trunk cable 3, but in this modified example, the branch cable 4 is a part of the trunk cable 3. This configuration has the same effect as the first embodiment.

### Modified Example of the Configuration Between the Resin Tube and the Third Connector

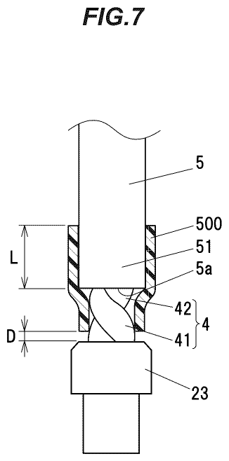

FIG. 7 is a configuration diagram showing a modified example in which a heat-shrinkable tube 500 is placed between the tip 51 of the resin tube 5 at the third connector 23 side and the third connector to prevent moisture and other substances from entering the resin tube 5. The heat-shrinkable tube 500 is a hollow tubular body made of a resin having a property of shrinking when heated, for example, polyolefin or the like, and covers the tip 51 of the resin tube 5 together with the signal lines 41, 42 that are derived out from the resin tube 5 toward the third connector 23.

As shown in FIG. 7, a length L of the heat-shrinkable tube 500 covering the resin tube 5 should be longer than a distance D between the tip of the heat-shrinkable tube 500 at the third connector 23 side and the third connector 23. This prevents the heat-shrinkable tube 500 from coming off the resin tube 5, for example, even if the heat-shrinkable tube 500 shrinks in the longitudinal direction due to heat applied to the heat-shrinkable tube 500 more than expected in the state of installation in the vehicle 100.

In other words, if the length of the heat-shrinkable tube 500 covering the resin tube 5 is short, the heat-shrinkable tube 500 may come off from the resin tube 5 when the heat-shrinkable tube 500 shrinks. However, covering the resin tube 5 with the heat-shrinkable tube 500 for a longer distance than the distance D can prevent the heat-shrinkable tube 500 from being detached from the resin tube 5 forming a gap subsequently, even if the heat-shrinkable tube 500 shrinks significantly in the state of installation in the vehicle 100. Furthermore, the movement of the entire heat-shrinkable tube 500 in the direction of detachment from the resin tube 5 is restricted by the third connector 23.

As the heat-shrinkable tube 500, it is desirable to use an adhesive-backed product with a hot-melt adhesive on the inner surface. By using an adhesive-backed product as the heat-shrinkable tube 50, misalignment of the heat-shrinkable tube 500 with respect to the resin tube 5 and a gap between the heat-shrinkable tube 500 and the resin tube 5 and signal lines 41, 42 can be prevented.

### Second Embodiment

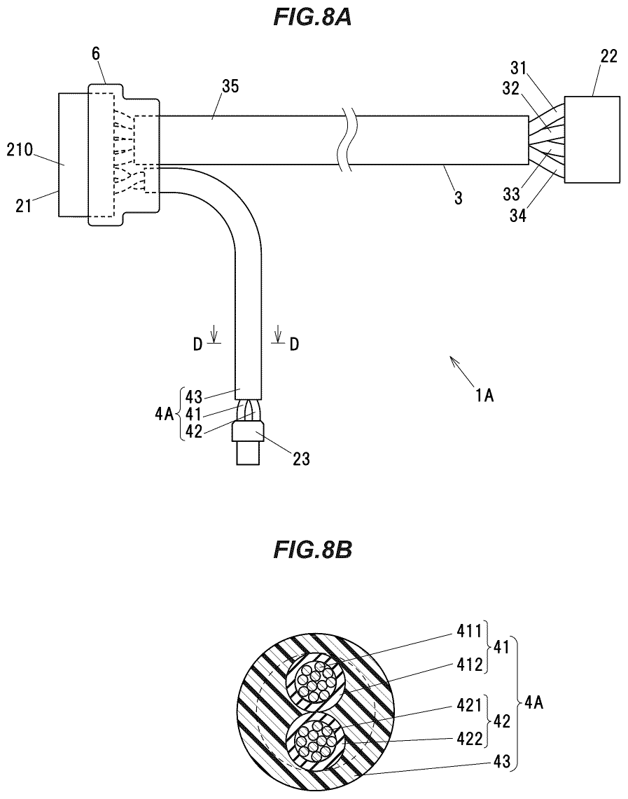

Next, a second embodiment will be explained with reference to FIG. 8. FIG. 8A is a configuration diagram of a wire harness 1A according to the second embodiment. FIG. 8B is a sectional view taken along the line D-D of FIG. 8A.

The wire harness 1A has a branch cable 4A in which the fifth and sixth signal lines 41, 42 are covered by a sheath 43. In FIG. 8A and FIG. 8B, members or the like common to those described in the first embodiment are marked with the same reference numerals as those used in the first embodiment, and redundant explanations are omitted.

In the first embodiment, a resin tube 5 is used as a protective member to protect the fifth and sixth signal lines 41, 42 of the branch cable 4. In the second embodiment, a sheath 43 formed by full extrusion around the fifth and sixth signal lines 41, 42 of the branch cable 4A is used as a protective member to protect the fifth and sixth signal lines 41, 42. The sheath 43 is made of urethane resin, for example, and is formed around the fifth and sixth signal lines 41, 42 by full extrusion so that it covers the fifth and sixth signal lines 41, 42 without gaps.

The fifth and sixth signal lines 41, 42 are derived from the sheath 43 at both ends of the branch cable 4A. The fifth and sixth signal lines 41, 42 derived from the sheath 43 at the end on the first connector 21 side are connected to the terminals of the first connector 21 as in the first embodiment. The fifth and sixth signal lines 41, 42, which are derived from the sheath 43 at the end of the third connector 23 side, are connected to the terminals of the third connector 23.

The sheath 43 of the branch cable 4A is partially covered at the first connector 21 side by the molded body 6 together with a part of the first connector 21 and the end of the sheath 35 of the trunk cable 3, and is welded to the molded body 6. This allows the second embodiment to achieve the same effect as in the first embodiment.

### Third Embodiment

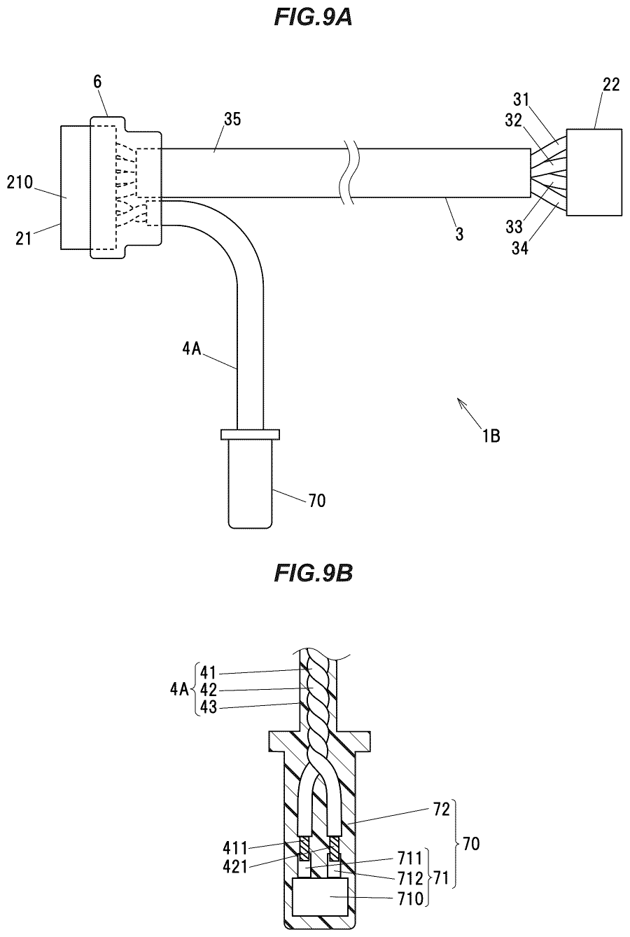

Next, a third embodiment will be explained with reference to FIG. 9. FIG. 9A is a configuration diagram of a wire harness 1B according to the third embodiment. FIG. 9B is a sectional view of the branch cable 4A and a sensor section 70 of the wire harness 1B according to the third embodiment. In FIGS. 9A and 9B, members or the like common to those described in the first and second embodiments are marked with the same reference numerals as those used in the first and second embodiments, and redundant explanations are omitted.

The wire harness 1B according to the third embodiment has the branch cable 4A with the same configuration as the second embodiment, but differs from the wire harness 1A according to the second embodiment in that it has the sensor section 70 at the end of the branch cable 4A. The sensor section 70 has a sensor element 71 that detects a physical quantity and a sealing member 72 that encapsulates (seals) the sensor element 71. In the present embodiment, the sensor element 71 is a magnetic field detection element that detects the intensity of a magnetic field. However, the sensor element 71 may detect other physical quantities.

The sensor element 71 has an element body 710 that converts physical quantities into electrical signals, and first and second terminals 711, 712. The center conductor 411 of the fifth signal line 41 is electrically connected to the first terminal 711 of the sensor element 71, and the center conductor 421 of the sixth signal line 42 is electrically connected to the second terminal 712 of the sensor element 71. The center conductor 411 of the fifth signal line 41 and the first terminal 711 of the sensor element 71, and the center conductor 421 of the sixth signal line 42 and the second terminal 712 of the sensor element 71, may be connected directly by solder, for example, or may be connected via lead wires or relay terminals, for example. Like the wheel speed sensor 7 of the first embodiment, the sensor section 70 is attached to the outer wheel 141 of the hub unit 14 and detects the rotation speed of the hub wheel 142 relative to the outer wheel 141 as the rotation speed of the vehicle wheel 11.

The sheath 43 of the branch cable 4A is integrally molded with the sealing member 72 of the sensor section 70. The sheath 43 and the sealing member 72 are made of urethane resin, for example. In manufacturing the wire harness 1B, the fifth and sixth signal lines 41, 42 and the sensor element 71 are connected in advance and placed in a mold, and molten resin is injected into the cavity of the mold. When the molten resin cools and solidifies, the branch cable 4A integrally having a sensor section 70 at the tip is obtained. The branch cable 4A is then placed together with the first connector 21 and the trunk cable 3 in the mold for molding the molded body 6, and the molded body 6 is molded.

The third embodiment also provides the same effect as the first embodiment. Since the sheath 43 of the branch cable 4A is integrally molded with the sealing member 72 of the sensor section 70, the penetration of moisture into the branch cable 4A can be reliably prevented.

### Summary of the Embodiments

Next, technical ideas understood from the first through third embodiments and modifications described above, will be described with reference to the reference numerals and the like used in the embodiments and modifications. However, each reference numeral in the following description does not limit the constituent elements in the scope of claims to the members and the like specifically shown in the embodiments and modifications.

According to the first feature, a wire harness 1, 1A, 1B includes a first cable and a second cable (a trunk cable 3 and a branch cable 4) each having a plurality of wires; a one-side connector a first connector 21 provided at one end of the first cable 3; and a protective member (a resin tube 5/a sheath 43) covering at least a portion of plurality of wires 41, 43/33, 34 of the second cable 4, wherein one end of the protective member 5/43 is covered by a molded body 6 together with the one-side connector 21.

According to the second feature, in the wire harness 1 as described by the first feature, the protective member is a tubular body the resin tube 5 that accommodates the second cable 4 including the plurality of wires 41, 42/33, 34.

According to the third feature, in the wire harness 1A, 1B as described by the first feature, the protective member is a solid sheath 43 covering the second cable 4 comprising the plurality of wires 41, 42.

According to the fourth feature, in the wire harness 1B as described by the third feature, the second cable 4 comprising the plurality of wires 41, 42 is connected to a sensor element 71 that detects a physical quantity, and the sheath 43 is integrally molded with a sealing member 72 that seals the sensor element 71.

According to the fifth feature, in the wire harness 1, 1A, 1B as described by any one of the first to fourth features, the protective members 5, 43 are welded to the molded body 6.

According to the sixth feature, in the wire harness 1, 1A, 1B as described by the fifth feature, the one-side connector 21 has a plurality of terminals 211 to 216 and a connector housing 210 that holds the plurality of terminals 211 to 216, wherein a portion of the connector housing 210 covered by the molded body 6 is welded to the molded body 6.

According to the seventh feature, in the wire harness 1, 1A, 1B as described by the first feature, the first cable 3 comprises a plurality of wires (first to fourth signal lines 31 to 34) covered by a sheath 35, and wherein the molded mold 6 covers a portion at the one-side connector 21 side in the sheath 35 of the first cable 3.

According to the eighth feature, in the wire harness 1, 1A as described by the first feature, further includes the other side connector (the second connector 22) disposed at the other end of the first cable 3, wherein an attachment object to the first connector 21 is a wheel-side control device (a brake controller 8) located on the wheel side of the vehicle 100 and an attachment object to the other side connector 22 is a vehicle-body-side control device (a general controller 9) located on the body side of the vehicle 100, and wherein the plurality of wires 41, 43/33, 34 of the second cable 4 are connected to a wheel speed sensor 7 that detects the rotation speed of the vehicle wheel 11.

The first through third embodiments and modifications have been described above. These embodiment and modifications do not limit the invention according to the scope of claims.

Additionally, it should be noted that not all combinations of features are essential to the means for solving problems of the invention.

In addition, the applications of the wire harness 1 are not limited to those described in the above embodiments, for example, the wire harness of this disclosure can be used to connect other devices, sensors, or the like in a vehicle. Furthermore, the wire harnesses of this disclosure may be used not only for vehicles, but also for industrial machinery and robots, for example.

1. A wire harness, comprising:
a first cable and a second cable, each having a plurality of wires;
a one-side connector disposed at one end of the first cable; and
a protective member covering at least a portion of the plurality of wires of the second cable,
wherein one end of the protective member is covered by a molded body together with the one-side connector.

2. The wire harness, according to claim 1, wherein the protective member is a cylindrical body that accommodates the plurality of wires of the second cable.

3. The wire harness, according to claim 1, wherein the protective member is a solid sheath covering the plurality of wires of the second cable.

4. The wire harness, according to claim 3, wherein the plurality of wires of the second cable are connected to a sensor element that detects a physical quantity, and wherein the sheath is integrally molded with a sealing member that seals the sensor element.

5. The wire harness, according to claim 1, wherein the protective member is welded to the molded body.

6. The wire harness, according to claim 5, wherein the one-side connector has a plurality of terminals and a connector housing that holds the plurality of terminals, and wherein a portion of the connector housing covered by the molded body is welded to the molded body.

7. The wire harness, according to claim 1, wherein the first cable comprises the plurality of wires covered by a sheath, and wherein the molded body covers a portion at a one-side connector side in the sheath of the first cable.

8. The wire harness, according to claim 1, further comprising:
an other-side connector on an other side of the first cable,
wherein an attachment object to the one-side connector is a wheel-side control device located on a wheel side of a vehicle,
wherein an attachment object to the other-side connector is a body-side control device located on a body side of the vehicle, and
wherein the plurality of wires of the second cable are connected to a wheel speed sensor that detects a rotation speed of a vehicle wheel.
